(19) United States
(12) Patent Application Publication
(10) Pub. No.: US 2016/0176753 A1
(43) Pub. Date: Jun. 23, 2016

(54) GLASS STRANDS CAPABLE OF REINFORCING ORGANIC AND/OR INORGANIC MATERIALS

(71) Applicant: OCV Intellectual Capital, LLC, Toledo, OH (US)

(72) Inventors: Emmanuel Lecomte, Bobigny (FR); Anne Berthereau, Challes Les Eaux (FR)

(21) Appl. No.: 15/055,893

(22) Filed: Feb. 29, 2016

Related U.S. Application Data
(63) Continuation of application No. 11/722,039, filed on Oct. 29, 2007.

(30) Foreign Application Priority Data
Dec. 16, 2004 (FR) 0413443

(51) Int. Cl. C03C 13/00; C03C 3/087

(52) U.S. Cl. CPC C03C 13/00; C03C 3/087

(57) ABSTRACT

The invention relates to glass reinforcement strands whose composition comprises the following constituents in the limits defined below, expressed as percentages by weight:

| | |
|---|---|
| SiO₂ | 50-65% |
| Al₂O₃ | 12-20% |
| CaO | 12-17% |
| MgO | 6-12% |
| CaO/MgO | ≦2, preferably ≧1.3 |
| Li₂O | 0.1-0.8%, preferably ≦0.6% |
| BaO + SrO | 0-3% |
| B₂O₃ | 0-3% |
| TiO₂ | 0-3% |
| Na₂O + K₂O | <2% |
| F₂ | 0-1% |
| Fe₂O₃ | <1%. |

These strands are made of a glass offering an excellent compromise between its mechanical properties, represented by the specific Young's modulus, and its melting and fiberizing conditions.

The present invention relates to glass “reinforcement” strands (or “fibers”), that is to say those that can reinforce organic and/or inorganic materials and can be used as textile strands, it being possible for these strands to be obtained by the process that consists in mechanically attenuating the streams of molten glass that flow out of orifices located in the base of a bushing, which is generally heated by resistance heating.

The present invention relates more specifically to glass strands having a high specific Young's modulus and having a particularly advantageous quaternary composition of the SiO₂—Al₂O—CaO—MgO type.

The field of glass reinforcement strands is a very special field in the glass industry. These strands are produced from specific glass compositions, the glass used having to be able to be drawn into the form of filaments a few microns in diameter using the process indicated above and having to allow the formation of continuous strands capable of fulfilling reinforcement function.

In certain applications, especially in aeronautics, the aim is to obtain large components capable of operating under dynamic conditions and consequently capable of withstanding high mechanical stresses. These components are usually based on organic and/or inorganic materials and on a reinforcement, for example in the form of glass strands, which in general occupies more than 50% of the volume.

The mechanical properties and the effectiveness of such components are improved by improving the mechanical performance of the reinforcement, especially the specific Young's modulus.

The properties of the reinforcement, in the case of glass reinforcement strands, are mainly governed by the composition of the constituent glass. Glass strands most widely used for reinforcing organic and/or inorganic materials are made of E-glass or R-glass.

E-glass strands are usually employed to form reinforcements, either as such or in the form of organized assemblies such as fabrics. The conditions under which E-glass can be fiberized are highly advantageous—the working temperature corresponding to the temperature at which the glass has viscosity close to 1000 poise is relatively low, of around 1200° C., the liquidus temperature is about 120° below the working temperature, and its devitrification rate is low.

The composition of E-glass defined in the ASTM D 578-98 standard for applications in the fields of electronics and aeronautics is the following (in percentages by weight): 52 to 56% SiO₂; 12 to 16% Al₂O₃; 16 to 25% CaO; 5 to 10% B₂O₂; 0 to 5% MgO; 0 to 2% Na₂O+K₂O; 0 to 0.8% TiO₂; 0.05 to 0.4% Fe₂O₃; and 0 to 1% F₂.

However, lass has in bulk a relatively low specific Young's modulus, of around 33 MPa/kg/m³.

The ASTM D 578-98 standard describes other E-glass reinforcement strands, optionally the glass containing no boron. These strands having the following composition (in percentages by weight): 52 to 62% SiO₂; 12 to 16% Al₂O₃; 16 to 25% CaC; 0 to 10% B₂O₃; 0 to 5% MgO; 0 to 2% Na₂O+K₂O, 0 to 1.5% TiO₂; 0.05 to 0.8% Fe₂O₃; and 0 to 1% F₂.

The fiberizing conditions for boron-free E-glass are less favourable than those for E-glass containing boron, but they do remain, however, economically acceptable. The specific Young's modulus remains at a performance level equivalent to that of E-glass.

Also known, from U.S. Pat. No. 4,199,364, is an inexpensive glass, containing neither boron nor fluorine, which has mechanical properties, especially a tensile strength, comparable to those of E-glass.

In bulk, R-glass is known for its good mechanical properties, especially as regards the specific Young's modulus, which is around 33.5 MPa/kg/m³. However, the melting and fiberizing conditions are more constrictive than in the case of the abovementioned types of E-glass, and therefore the final cost of R-glass is higher.

The composition of R-glass is given in FR-A-1 435 073, this being the following (in percentages by weight): 50 to 65% SiO₂; 20 to 30% Al₂O₃; 2 to 10% CaO, 5 to 20% MgO; 15 to 25% CaO+MgO; SiO₂/Al₂O₃=2 to 2.8; MgO/SiO₂<0.3.

Other attempts at increasing the mechanical strength of glass strands have been made, but generally to the detriment of their fiberizability, the processing then becoming more difficult or imposing the need to modify existing fiberizing installations.

There is therefore a need to have glass reinforcement strands having a cost as close as possible to that of E-glass and exhibiting mechanical properties at a performance level comparable to that of R-glass.

The object of the present invention is to provide such glass reinforcement strands that combine the mechanical properties of R-glass, in particular its specific Young's modulus, with improved melting and fiberizing properties, approaching those of E-glass.

This object is achieved thanks to glass strands whose composition comprises the following constituents in the limits defined below, expressed as percentages by weight:

| | |
|---|---|
| SiO₂ | 50-65% |
| Al₂O₃ | 12-20% |
| CaO | 12-17% |
| MgO | 6-12% |
| CaO/MgO | ≦2, preferably ≧1.3 |
| Li₂O | 0.1-0.8%, preferably ≦0.6% |
| BaO + SrO | 0-3% |
| B₂O₃ | 0-3% |
| TiO₂ | 0-3% |
| Na₂O + K₂O | <2% |
| F₂ | 0-1% |
| Fe₂O₃ | <1%. |

Silica (SiO₂) is one of the oxides that forms the network of the glasses according to the invention and plays an essential role in their stability. Within the context of the invention, when the silica content is less than 50%, the viscosity of the glass becomes too low and there is an increased risk of devitrification during fiberizing. Above 65%, the glass becomes very viscous and difficult to melt. Preferably, the silica content is between 58% and 63%.

Alumina (Al₂O₃) also constitutes a network former for the glasses according to the invention and plays an essential role with regard to the modulus, combined with silica. Within the context of the defined limits according to the invention, reducing the percentage concentration of this oxide to below 12% results in a reduction in the specific Young's modulus and contributes to increasing the maximum devitrification, rate, whereas too large an increase in the percentage concentration of this oxide, to above 20%, runs the risk of devitrification and increases the viscosity. Preferably, the alumina content of the selected compositions lies in the range from 13 to 18%. Advantageously, the sum of the silica and alumina contents is greater than 70% and better still greater than 75%, which makes possible to achieve advantageous values of the specific Young's modulus.

Lime (CaO) is used to adjust the viscosity and to control the devitrification of the glasses. The CaO content preferably lies in the range from 13 to 15%.

Magnesia (MgO), like CaO, acts as a viscosity reducer and also has a beneficial effect on the specific Young's modulus. The MgO content lies in the range from 6 to 12%, preferably from 7 to 9%.

The CaO/MgO weight ratio proves to be an essential factor for controlling devitrification. The inventors have identified that a CaO/MgO ratio not exceeding 2, but preferably greater than 1.3, promotes crystallization of the glass in several phases (anorthite: CaO.Al₂O₃.2SiO₂ and diopside: CaO.MgO.2SiO₂, or even forsterite: 2MgO.SiO₂ or enstatite: MgO.SiO₂) which enter into competition for growth at the expense of the liquid phase. This competition has the effect of limiting the maximum growth rate of the crystalline phases and therefore reducing the risk of the glass devitrifying, and of allowing it to be fiberized correctly.

Other alkaline-earth metal oxides, for example BaC and SrO, may be present in the glass composition. The total content of these oxides is kept below 3%, preferably below 1%, so as not to increase the density of the glass, which would have the effect of lowering the specific Young's modulus. As a general rule, the composition contains substantially no BaO and SrO.

Lithium oxide (Li₂O) like MgO acts as a viscosity reducer and also increases the specific Young's modulus. Above 0.8%, Li₂O results in a substantial reduction in the working temperature, and therefore in the forming range (the difference between the working temperature and the liquidus temperature), which would no longer allow the glass to be fiberized satisfactorily.

Furthermore, Li₂O is costly, as it is essentially provided by two raw materials, one synthetic and expensive, namely lithium carbonate, and the other natural, namely spodumene which contains only 7 to 8% Li₂O and therefore has to be introduced in a large amount into the batch. Lithium oxide is also highly volatile, resulting in a loss of about 50% during melting. For all these reasons, the Li₂O content in the glass composition according to the invention varies from 0.1 to 0.8% and is preferably limited to 0.6% and better still 0.5%.

Preferably, the sum of the Al₂O₃, and MgO and Li₂O contents is equal to 23% or higher, thereby making it possible to obtain very satisfactory specific Young's modulus values (of greater than 36 MPa/kg/m³) while still having good fiberizability.

Boron oxide (B₂O₃) acts as a viscosity reducer. Its content in the glass composition according to the invention is limited to 3%, preferably 2%, in order to avoid problems of volatilization and emission of pollutants.

Titanium oxide acts as a viscosity reducer and helps to increase the specific Young's modulus. It may be present as an impurity (its content in the composition is then from 0 to 0.5%) or it may be intentionally added. However, its intentional addition requires the use of non-standard raw materials that introduce the fewest possible impurities into the batch, thereby increasing the cost. The deliberate addition of TiO₂ is advantageous only for a content of less than 3%, preferably less than 2%, as above this, the glass assumes an undesirable yellow color.

Na₂O and K₂O may be introduced into the composition according to the invention in order to contribute to limiting devitrification and possibly to reduce the viscosity of the glass. However, the content of Na₂O and K₂O must remain below 2% in order to avoid jeopardizing the hydrolytic resistance of the glass. Preferably, the composition contains less than 0.8% of these two oxides.

Fluorine (F₂) may be present in the composition in order to help in glass melting and in fiberizing. However, its content is limited to 1%, as above this there may be the risk of polluting emissions and of corrosion of the furnace refractories.

Iron oxides (expressed in Fe₂O₃ form) are generally present as impurities in the composition according to the invention. The Fe₂O₃ content must be below 1%, preferably equal to 0.5% or less, in order not to unacceptably impair the color of the strands and the operation of the fiberizing installation, in particular heat transfers in the furnace.

Preferably, the glass strands have a composition comprising the following constituents in the limits defined below, expressed in percentages by weight:

| | |
|---|---|
| SiO₂ | 58-63% |
| Al₂O₃ | 13-18% |
| CaO | 12.5-15% |
| MgO | 7-9% |
| CaO/MgO | 1.5-1.9 |
| Li₂O | 0.1-0.5% |
| BaO + SrO | 0-1% |
| B₂O₃ | 0-2% |
| TiO₂ | 0-0.5% |
| Na₂O + K₂O | <0.8% |
| F₂ | 0-1% |
| Fe₂O₃ | <0.5.%. |

It is particularly advantageous for the composition to have an Al₂O₃/(Al₂O₃+CaO+MgO) weight ratio that ranges from 0.40 to 0.44, and is preferably equal to 0.42 or less, thereby making it possible to obtain glasses that have a liquidus temperature of 1250° C. or below, preferably of 1210° C. or below.

As a general rule, the glass strands according to the invention contain no boron oxide B₂O₃ or fluorine F₂.

The glass strands according to the invention are obtained from the glasses of the composition described above using the following process: a large number of streams of molten glass flowing out of a large number of orifices located in the base of one or more bushings are attenuated into the form of one or more sheets of continuous filaments and then these filaments are combined into one or more strands, which are collected on a moving support. This may be a rotating support, when the strands are collected in the form of wound packages, or in the form of a support that moves translationally when the strands are chopped by a device that also serves to draw them or when the strands are sprayed by a device serving to draw them, so as to form a mat.

The strands obtained, optionally after further conversion operations, may thus be in various forms: continuous strands, chopped strands, woven fabrics, knitted fabrics, braids, tapes or mats, these strands being composed of filaments whose diameter may range from about 5 to 30 microns.

The molten glass feeding trio bushings is obtained from pure raw materials or, more usually, natural raw materials (that is to say possibly containing trace impurities), these raw materials being mixed in appropriate proportions, and then melted. The temperature of the molten glass is conventionally regulated so as to allow it to be fiberized and to avoid devitrification problems. Before the filaments are combined in the form of strands, they are generally coated with a size composition with the aim of protecting them from abrasion and allowing them to be subsequently incorporated into the materials to be reinforced.

The composites obtained from the strands according to the invention comprise at least one organic material and/or at least one inorganic material and glass strands, at least some of the strands being the strands according to the invention.

The following examples illustrate the invention without however limiting it.

Glass strands made up of glass filaments 17 μm in diameter were obtained by attenuating molten glass having the composition given in Table 1, expressed in percentages by weight.

The temperature at which the viscosity of the glass is equal to 10³ poise (decipascals·second) is denoted by T(log η=3).

The liquidus temperature of the glass is denoted by T_{liquiduss}, this temperature corresponding to that at which the most refractory phase that can devitrify in the glass has a zero growth rate and thus corresponds to the melting point of this devitrified phase.

The value of the specific Young's modulus of the glass in bulk calculated from the Young's modulus measured according to the ASTM C 1259-01 standard and from the density measured by the Archimedes method (i.e. the measured specific Young's modulus) and the value calculated from a model established on the basis of existing data using a statistical software package (i.e. the calculated specific Young's modulus) are reported. A good correlation exists between the specific Young's modulus measured on bulk glass and the specific Young's modulus of a roving consisting of filaments made from this same glass. Consequently, the values in Table 1 provide an estimate of the mechanical properties in terms of modulus of the glass after fiberizing. The table also gives, as comparative examples, the measurements on a glass containing no Li₂O (Example 6), on the glass according to Example of U.S. Pat. No. 4,199,364 (Example 7) and on E-glass and R-glass.

It appears that the examples according to the invention exhibit an excellent compromise between melting and fiberizing properties and mechanical properties. These fiberizing properties are particularly advantageous, especially with a liquidus temperature of around 1210° C., which is much lower than that of R-glass. The fiberizing range is positive, in particular with a difference between T(log η=3) and T_{liquidus} of more than 50° C., and possibly up to 68° C.

The specific Young's modulus of the glass obtained from the compositions according to the invention (Examples 1 to 5) is markedly higher than that of E-glass and also improved over that of R-glass and the glass containing no Li₂O (Example 6).

Remarkably, with the glasses according to the invention, substantially better mechanical properties than those of R-glass are thus achieved, while appreciably lowering the fiberizing temperature, bringing it close to the value obtained for E-glass.

The glasses according to the invention crystallize in three phases. At the liquidus, the phase is diopside, which is more favorable as it is less refractory than anorthite (Example 6). The maximum growth rate of diopside is lower than in the case of the glass of Example 7 for which the CaO/MgO ratio is 2.14 (a reduction of at least 50%).

The glass strands according to the invention are less expensive than R-glass strands, which may advantageously be replaced in certain applications, especially aeronautical applications, or for reinforcement of helicopter blades, or for optical cables.

TABLE 1

| | Ex. 1 | Ex. 2 | Ex. 3 | Ex. 4 | Ex. 5 | Ex. 6 | Ex. 7 | E-glass | R-glass |
|---|---|---|---|---|---|---|---|---|---|
| SiO₂ (%) | 60.75 | 60.70 | 61.50 | 61.50 | 61.50 | 59.46 | 60.48 | 54.4 | 60.0 |
| Al₂O₃ (%) | 15.80 | 15.90 | 15.05 | 14.80 | 15.40 | 15.94 | 15.29 | 14.5 | 25.0 |
| CaO (%) | 13.90 | 13.50 | 13.90 | 13.90 | 13.55 | 14.84 | 15.00 | 21.2 | 9.0 |
| MgO (%) | 7.90 | 8.40 | 7.90 | 7.90 | 7.70 | 8.77 | 6.99 | 0.3 | 6.0 |
| CaO/MgO | 1.75 | 1.60 | 1.76 | 1.76 | 1.76 | 1.70 | 2.14 | 70.6 | 1.5 |
| Li₂O (%) | 0.48 | 0.50 | 0.50 | 0.75 | 0.75 | — | 0.60 | — | — |
| B₂O₃ (%) | — | — | — | — | — | — | — | 7.3 | — |
| TiO₂ (%) | 0.12 | 0.12 | 0.12 | 0.12 | 0.12 | 0.13 | 0.64 | — | — |
| Na₂O + K₂O (%) | 0.73 | 0.73 | 0.73 | 0.73 | 0.73 | 0.39 | 0.69 | 0.6 | — |
| Fe₂O₃ (%) | 0.18 | 0.18 | 0.18 | 0.18 | 0.18 | 0.24 | 0.31 | — | — |
| T(logη = 3) (° C.) | | | | | | | | | |
| calculated | 1278 | 1275 | 1278 | 1264 | 1271 | 1286 | n.d. | n.d | n.d. |
| measured | 1269 | n.d. | n.d | n.d | n.d | 1281 | n.d. | 1203 | 1410 |
| T_{liquidus} (° C.) | 1210 | (1210) * | (1210) * | (1210) * | (1210) | 1220 | 1210 | 1080 | 1330 |
| T(logη = 3) − T_{liquidus} (° C.) | 59 | (65) * | (68) * | (54) * | (61) * | 61 | n.d. | 123 | 80 |
| Specific Young's modulus | | | | | | | | | |
| MPa/kg/m³) | | | | | | | | | |
| calculated | 36.10 | 36.30 | 36.20 | 36.60 | 36.60 | 35.50 | n.d. | n.d. | 35.50 |
| measured | 36.20 | n.d. | n.d. | n.d. | n.d. | 35.10 | 35.60 | 33.30 | 35.55 |
| Phase at the liquidus | Diopside | n.d. | Diopside | n.d. | n.d. | Anorthite | Diopside | n.d. | n.d. |
| Vmax (*m/min) at T(Vmax) (° C.) | 4.9/1060 | n.d. | 3.9/1100 | n.d. | n.d. | 1.9/1100 | 9.8/1100 | n.d. | n.d. |
| Phase 2 | Anorthite | n.d. | Anorthite | n.d. | n.d. | Diopside | Anorthite | n.d. | n.d. |
| Vmax (*m/min) at T(Vmax) (° C.) | 2.4/1020 | n.d. | 2.4/1060 | n.d. | n.d. | 3.3/1140 | 1.63/1020 | n.d. | n.d. |
| Phase 3 | Forsterite | n.d. | Enstatite | n.d. | n.d. | Forsterite | — | n.d. | n.d. |
| Vmax (*m/min) at T(Vmax) (° C.) | 0.5/1020 | n.d. | 0.5/1020 | n.d. | n.d. | 0.4/1080 | — | n.d. | n.d. |

n.d.: not determined
* calculated value

1-35. (canceled)

36. A glass reinforcement strand formed from a composition comprising the following constituents in the limits defined below, expressed as percentages by weight:

| | |
|---|---|
| SiO₂ | 58-63% |
| Al₂O₃ | 12-20% |
| CaO | 12-17% |
| MgO | 6-12% |
| CaO/MgO | ≦2 |
| Li₂O | 0.1-0.8% |
| BaO + SrO | 0-3% |
| B₂O₃ | 0-3% |
| TiO₂ | 0-3% |
| Na₂O + K₂O | <2% |
| F₂ | 0-1% |
| Fe₂O₃ | <1%, |

wherein the composition has an Al₂O₃+MgO+Li₂O content equal to 23% or higher, and wherein said glass strand has a specific Young's modulus of at least 36 MPa/Kg/m³.

37. The class strand as claimed in claim 36, wherein the composition has an SiO₂+Al₂O₃ content of greater than 70%.

38. The glass strand as claimed in claim 36, wherein the composition has an Al₂O₃/(Al₂O₃+CaO+MgO) weight ratio that ranges from 0.40 to 0.44.

39. The glass strand as claimed in claim 36, wherein said composition contains no F₂.

40. The glass strand as claimed in claim 36, wherein said composition comprises a CaO/MgO ratio of ≧1.3 and ≦2.

41. The glass strand as claimed in claim 36, wherein said composition contains no B₂O₃.

42. The glass strand as claimed in claim 36, wherein said glass stand possesses an anorthite crystallization phase, a diopside crystallization phase, and a forsterite crystallization phase.

43. The glass strand as claimed in claim 36, wherein said composition comprises 13-15% by weight CaO.

44. The glass strand as claimed in claim 36, wherein said composition comprises 12.5-13.9% by weight CaO.

45. The glass strand as claimed in claim 36, wherein said glass strand has a liquidus temperature of less than or equal to 1,210° C.

46. An assembly comprising a plurality of the glass strands of claim 36.

47. A composite comprising a plurality of the glass strands of claim 36 and at least one of an organic material and an inorganic material.

48. A glass composition for producing glass reinforcement strands, said glass composition comprising the following constituents in the limits defined below, expressed as percentages by weight:

| | |
|---|---|
| SiO₂ | 58-63% |
| Al₂O₃ | 12-20% |
| CaO | 12-17% |
| MgO | 6-12% |
| CaO/MgO | ≦2 |
| Li₂O | 0.1-0.8% |
| BaO + SrO | 0-3% |
| B₂O₃ | 0-3% |
| TiO₂ | 0-3% |
| Na₂O + K₂O | <2% |
| F₂ | 0-1% |
| Fe₂O₃ | <1%, |

wherein the composition has an Al₂O₃/(Al₂O₃+CaO+MgO) weight ratio that ranges from 0.40 to 0.44 and wherein said glass strand has a liquidus temperature of 1,210° C. or below.

49. The composition as claimed in claim 48, wherein said composition has a forming range (T(log η=3)−T_{liquidus}) of more than 50° C.

50. The composition as claimed in claim 48, wherein said composition comprises a CaO/MgO ratio of ≧1.3 and ≦2.

51. The composition as claimed in claim 48, wherein said composition contains no B₂O₃.

52. A glass reinforcement strand formed from a composition comprising the following constituents, expressed as percentages by weight:

| | |
|---|---|
| SiO₂ | 58-63% |
| Al₂O₃ | 13-18% |
| CaO | 12.5-15% |
| MgO | 7-9% |
| CaO/MgO | 1.5-1.9 |
| Li₂O | 0.1-0.6% |
| BaO + SrO | 0-1% |
| B₂O₃ | 0-2% |
| TiO₂ | 0-0.5% |
| Na₂O + K₂O | <0.8% |
| F₂ | 0-1% |
| Fe₂O₃ | <0.5%, |

wherein said glass strand has a specific Young's modulus of at least 36 MPa/Kg/m³.

53. The glass strand as claimed in claim 52, wherein the composition has an SiO₂+Al₂O₃ content greater than 70%.

54. The glass strand as claimed in claim 52, wherein the composition has an Al₂O₃/(Al₂O₃+CaO+MgO) weight ratio that ranges from 0.40 to 0.44.

55. The glass strand as claimed in claim 52, wherein said composition contains no B₂O₃.

56. A glass reinforcement strand formed from a composition comprising the following constituents in the limits defined below, expressed as percentages by weight:

| | |
|---|---|
| SiO₂ | 58-63% |
| Al₂O₃ | 12-20% |
| CaO | 12-17% |
| MgO | 7-9% |
| CaO/MgO | ≦2 |
| Li₂O | 0.1-0.8% |
| BaO + SrO | 0-3% |
| B₂O₃ | 0-3% |
| TiO2 | 0-3% |
| Na₂O + K₂O | <2% |
| F₂ | 0-1% |
| Fe₂O₃ | <1%, |

wherein said glass strand has a liquidus temperature of less than or equal to 1,250° C. and wherein said glass strand has a specific Young's modulus of at least 36 MPa/Kg/m³.

57. The glass reinforcement strand as claimed in claim 56, wherein said composition has a forming range (T(log η=3)−T_{liquidus}) greater than 50° C.

58. The glass reinforcement strand as claimed in claim 56, wherein said composition has an Al₂O₃/(Al₂O₃+CaO+MgO) weight ratio that ranges from 0.40 to 0.44.
